(19) United States
(12) Patent Application Publication
(10) Pub. No.: US 2008/0256030 A1
(43) Pub. Date: Oct. 16, 2008

(54) FINE-GRAINED AUTHORIZATION FRAMEWORK

(75) Inventor: Eugene Haskell Clark, Belmont, MA (US)

Correspondence Address: BURNS & LEVINSON, LLP, 125 SUMMER STREET, BOSTON, MA, 02110, US

(73) Assignee: MASSACHUSETTS GENERAL HOSPITAL, Boston, MA (US)

(21) Appl. No.: 12/101,256

(22) Filed: Apr. 11, 2008

Related U.S. Application Data
(60) Provisional application No. 60/911,441, filed on Apr. 12, 2007.

(51) Int. Cl. H04L 9/32; G06F 17/30; G06F 12/12; G06F 12/08; G06F 15/16

(52) U.S. Cl. 707/2; 726/2; 707/103 R; 711/135; 711/216; 709/203; 726/3; 707/E17.055; 711/E12.069; 711/E12.018

(57) ABSTRACT

A system and method for controlling access to an instance method on an instance-specific basis by intercepting an invocation of the instance method on an instance.

### CROSS REFERENCE TO RELATED APPLICATIONS

This application claims priority under 35 U.S.C. § 119 from U.S. Provisional Patent Application Ser. No. 60/911,441 entitled FINE-GRAINED AUTHORIZATION FRAMEWORK, filed on Apr. 12, 2007.

### BACKGROUND

Applications that execute in the context of a distributed multitiered application model can rely on a role-based security mechanism that allows application developers to control access on an instance method by instance method basis. In such an environment, application logic can be divided into components according to function, and application components can be installed on different machines depending upon where in the application model the component belongs. For applications that need to enforce data access rules, the role-based security mechanism can be inadequate. It can be augmented, for example, by embedding data access control code in business logic, or by attaching “ownership” attributes to every entity, or by using “security by reachability”. The first approach can be hard to maintain and can leave open the possibility of poor code's causing a security breach. The second approach can be more secure but can also raise maintenance overhead and reduce flexibility, especially when it is necessary to grant varying levels of access. The last approach may not control access to data. What is needed is a data access enforcement mechanism that is separate from business logic and where ownership attributes are not integral with the data managed by the application.

### SUMMARY

The needs set forth above as well as further and other needs and advantages are addressed by the illustrative embodiment described herein below.

The method of the present embodiment can include, but is not limited to including, the steps of (a) intercepting an invocation of the instance method, having an instance method invocation identification, on an instance, having instance identification; (b) determining a caller of the instance method invocation identification; (c) associating the caller with a caller access control cache on a computer readable medium, the caller access control cache having an instance segment including a set of the instance method invocation identifications, the caller access control cache having a grant segment including a grant set of the instance method invocation identifications, the caller access control cache having a deny segment including a deny set of the instance method invocation identifications, the caller access control cache having a high/low segment including a set of ranges for the instance method invocation identifications for each access control rule; (d) associating the caller access control cache with a transaction; (e) granting, to the caller, access to the instance invoked by the instance method having the instance method invocation identification if the instance method invocation identification matches one of the set, or if the instance method invocation identification matches one of the grant set; (f) adding the instance method invocation identification to the set and repeating steps (a) through (f) if the instance method invocation created a new instance; (g) denying, to the caller, access to the instance invoked by the instance method having the instance method invocation identification and repeating steps (a) through (g) if the instance method invocation identification matches one of the deny set; (h) adding the instance method invocation identification to the deny segment and repeating step (g) if there are no more of the instance access control rules associated with the instance invoked by the instance method having the instance method invocation identification; (i) repeating step (h) if the instance method invocation identification is within the high/low set for the instance access control rule or if the instance access control rule does not define a scope that matches the caller and an application context associated with the transaction; (j) determining additional of the instance methods with which the instance access control rule is associated if there are more of the instance access control rules associated with the instance, and if the instance method invocation identification is outside the high/low set for the instance access control rule, and if the instance access control rule defines the scope that matches the caller and the application context; (k) optimizing a query of the instance access control rule; (l) determining results from executing the optimized query of the instance access control rule; (m) storing the results and additional of the instance methods with which the instance access control rule is associated in the grant segment and the high/low segment of the caller access control cache in the computer readable medium; (n) granting, to the caller, access to the instance invoked by the instance method having the instance method invocation identification and repeating steps (a) through (f) if the instance method invocation identification matches an entry in the results; and (o) repeating steps (h)-(n) if the instance method invocation identification matches no entry in the results.

The system of the present embodiment can include, but is not limited to including, a caller access control cache associated with a caller, an instance segment having a set of instance method invocation identifications; a grant segment having a grant set of said instance method invocation identifications; a deny segment having a deny set of said instance method invocation identifications; a high/low segment including a set of non-overlapping instance identification ranges for each access control rule; an associater associating said caller access control cache with a transaction; an interceptor intercepting a method invocation having said instance method invocation identification; an access control engine for granting and denying access according to the method of the present embodiment.

For a better understanding of the present embodiment, together with other and further objects thereof, reference is made to the accompanying drawings and detailed description.

### DESCRIPTION OF THE SEVERAL VIEWS OF THE DRAWING

FIG. 1 is a schematic block diagram of a distributed multitiered application model environment in which the system and method of the present embodiment can execute;

FIG. 2 is a schematic block diagram of the system of the present embodiment; and

FIGS. 3A, 3B, 4, and 5 are flow charts of methods of the present embodiments.

### DETAILED DESCRIPTION

The present embodiment is now described more fully hereinafter with reference to the accompanying drawings. The following configuration description is presented for illustrative purposes only. Any computer configuration and multitiered distributed architecture satisfying the speed and interface requirements herein described may be suitable for implementing the system and method of the present embodiment.

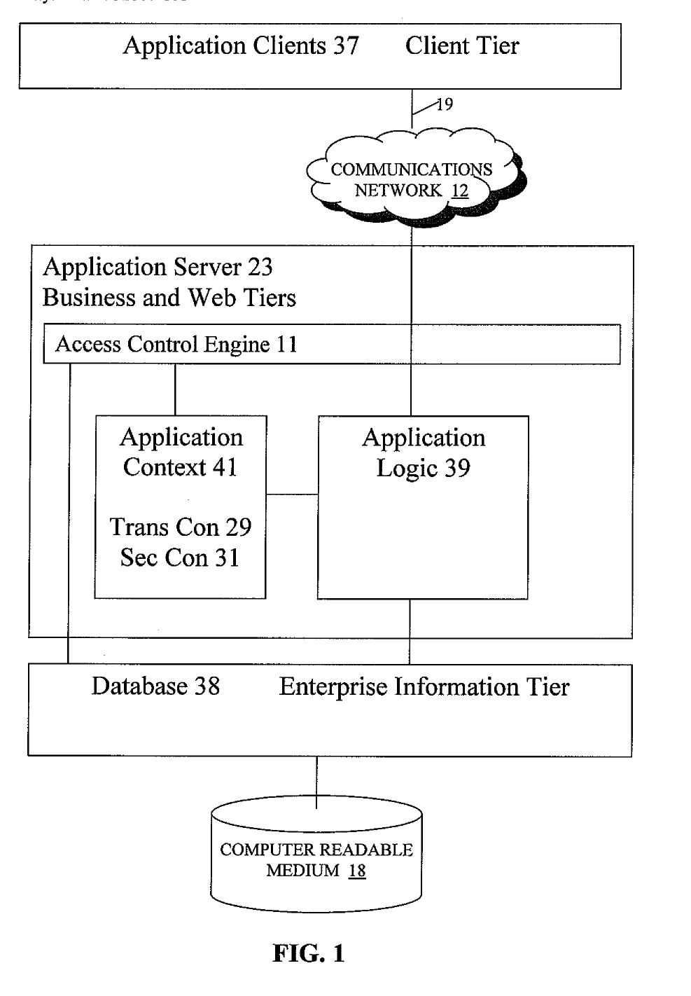

Referring now to FIG. 1, the system and method of the present embodiment augment a role-based security mechanism found in an environment such as the JAVA Platform, Enterprise Edition (J2EE®) environment sold by SUN MIRCROSYSTEMS®, Inc., where the augmentation can allow application developers to control access by enabling enforcement of data access rules. An environment such as the J2EE® environment can include client, web, business, and enterprise information tiers, executing on, for example, three machines, i.e. application client 37 executing the client tier, application server 23 executing the web and business tiers, and database 38 executing the enterprise information tier. Application client 37 can provide a way for users to handle tasks that require a richer user interface than can be provided by a markup language such as XML. Application client 37 can have, for example, a graphical user interface (GUI) or a command-line interface. Application client 37 can directly access business components, referred to herein as enterprise beans, executing in the business tier. However, if application requirements warrant it, application client 37 can establish communication with a servlet, for example, by opening an HTTP connection, executing in the web tier. Enterprise beans can represent, for example, transient conversations with application client 37) or can represent persistent data stored in one row of a database table, or can allow a business component to receive messages asynchronously.

Continuing to refer to FIG. 1, access control engine 11 can provide instance level security by expanding a role-based security mechanism (that can be provided in an environment such as the J2EE® environment) by use of an enforcement mechanism that is “instance aware”, which means that the enforcement mechanism checks method access for the particular bean instance. The system and method of the present embodiment accommodate business context changes by allowing for data access rules that can vary. This can be accomplished by processing entity beans as database table proxies and by handling access to entities in the same way that low-level data access control is handled. Instead of attaching “ownership” attributes to every entity through data access control code embedded in business logic, or instead of enforcing security by limiting reachability, the system and method of the present embodiment separate data access enforcement mechanisms from business logic, and ownership attributes from the data managed by the application. Application client 37 can access application logic 39 through access control engine 11, where application logic 39 is associated with application context 41 which can include, but is not limited to including, transaction context 29 and security context 31. As shown, access control engine 11 can interface with application context 41 and can provide security services with respect to access and modification of application data by application logic 39.

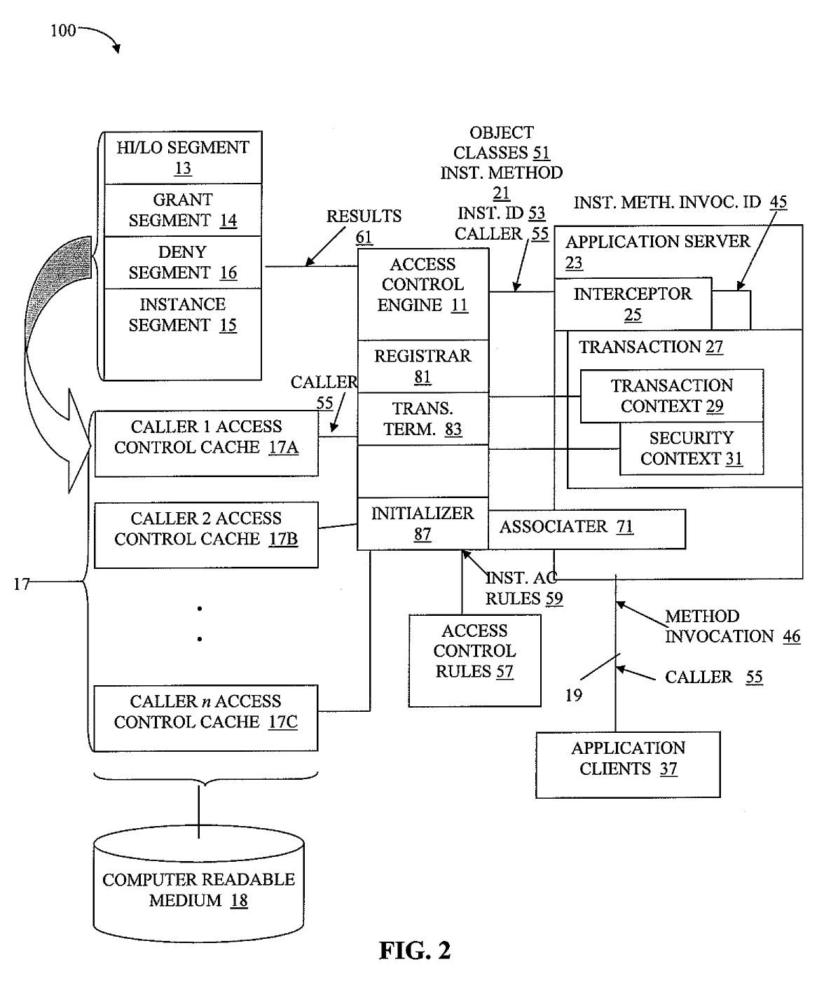

Referring now to FIG. 2, system 100 can include, but is not limited to including, caller access control cache 17 associated with caller 55, access control engine 11 coupled with caller access control cache 17, associater 71 capable of associating caller access control cache 17 with transaction 27 and with a user, interceptor 25 capable of intercepting method invocation 46 of instance method 21 executing in transaction context 29 of transaction 27, wherein transaction 27 is associated with caller 55. Access control engine 11 can be configured to, but is not limited to being configured to, executing instance access control rules 59 to determine a list of instance identifications of instances to which caller 55 has access, adding new instance identifications to instance segment 15 associated with caller 55, transferring a subset of a list that includes instances that are a pre-selected numeric distance from instance method invocation identifier 45 into caller access control cache 17, and granting caller 55 access to the instance invoked by instance method 21 associated with instance method invocation identifier 45 if the instance is included in caller access control cache 17 or is a instance. Access control engine 11 can be further configured to clear instance segment 15 when transaction 27 completes. Associater 71 can be further configured to determine caller 55, and, if caller access control cache 17 for caller 55 exists, determine caller access control cache 17 for the caller 55. If caller access control cache 17 for caller 55 does not exist, associater 71 can be configured to create a new caller access control cache 17 including a nested hash map of the grant set, the deny set, and the set associated with transaction 27, and a hierarchical data structure having levels including object class names represented as a hash map, method group names represented as a hash map, and the instance method invocation identification 45 represented as a hash set. Associater 71 can further be configured to bind caller access control cache 17 to a thread-local variable for faster retrieval on subsequent access checks within transaction 27, retrieve transaction context 29, and register a callback object with transaction 27 so that transaction 27 can receive notification of a transaction completion a capability accessible through a commercially available applications programming interface such as, for the example, an interface defined for J2EE®. Transaction 27 represents a logical unit of work that application client 37 executes through application logic 39. Access control engine 11 can manage an internal state of transaction 27 by associating data structures with transaction context 29. That is, access control engine 11 can maintain data structures whose lifecycle is determined by the lifecycle of transaction 27. Two data structures that are bound to the lifecycle of transaction 27, and thus to transaction context 29, are instance segment 15 of caller access control cache 17 and the binding of caller access control cache 17 to a thread local variable, both of which are cleared upon completion of transaction 27. In addition, there is one instance segment 15 within caller access control cache 17 for each transaction 27 during which a new instance has been created (to support nested transactions 27).

Continuing to refer to FIG. 2, when a new instance is created, access control engine 11 can register the new instance in instance segment 15 of the caller access control cache 17. For the duration of transaction 27 in which the instance was created, any subsequent invocation on that instance can be allowed without checking any rules. At the end of transaction 27, instance segment 15 can be cleared. Each caller 55 can be given a dedicated instance of caller access control cache 17 that stores authorization information for, for example, the duration of transaction 27, or until no activity has been registered with the caller access control cache 17 for a specified period of time (for example, thirty minutes). Caller access control cache 17 can contain, but is not limited to containing, segments such as grant segment 14 capable of storing access grants, deny segment 16 capable of storing access denials, instance segment capable of storing instance information, and high/low segment 13 capable of storing per-rule high/low records. In the illustrative embodiment, grant segment 14, deny segment 16, and instance segment 15 have the same data structure, which itself can be divided into at least two parts: one part to store object classes 51 that have instances and one part to store object classes 51 that do not have instances. Both parts can use, for example, a hierarchical hash structure, or another sort of structure that can optimize for lookup speed. In the hierarchical hash structure, the top-level can be the class name, the second level can be the method group, and another lower level can be the list of instance method invocation identifications 45 for object classes 51 that have instances. In the illustrative embodiment, a set of global data elements can be used within the data structure in caller access control cache 17 for class and method group names for optimizing lookups. The global data elements can be used throughout access control engine 11, and identity, rather than content, can be used to determine equality.

Continuing to still further refer to FIG. 2, system 100 can further include registrar 81 that can be configured to register object class 51 with access control engine 11, load instance access control rules 59 for object class 51, prepare instance access control rules 59 for execution, and store the prepared instance access control rules in access control engine 11. Registrar 81 can be further configured to optimize a structure for object class 51 to accommodate access checking. System 100 can further include transaction terminator 83 that can be configured to receive a notification that transaction 27 has completed, retrieve caller access control cache 17 associated with transaction 27, clear instance segment 15 of caller access control cache 17, and disassociate caller access control cache 17 from transaction 27. System 100 can further include initializer 87 for initializing the access control engine 11, where initializer 87 can be configured to determine configuration information from an XML file, wherein the configuration information can include transaction, security, and variable resolution connectors, define a security object that can be a representation of caller 55 that is understood by access control engine 11, and integrate queries defined outside of access control rules 57 with access control rules 57.

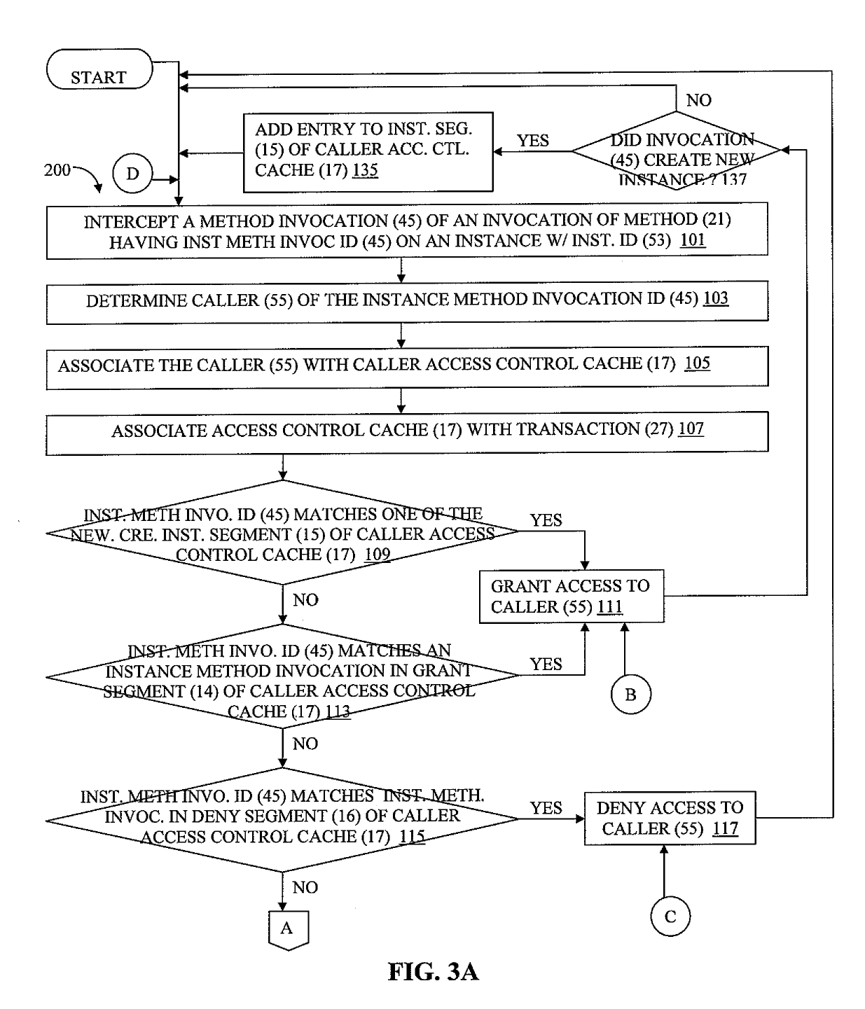

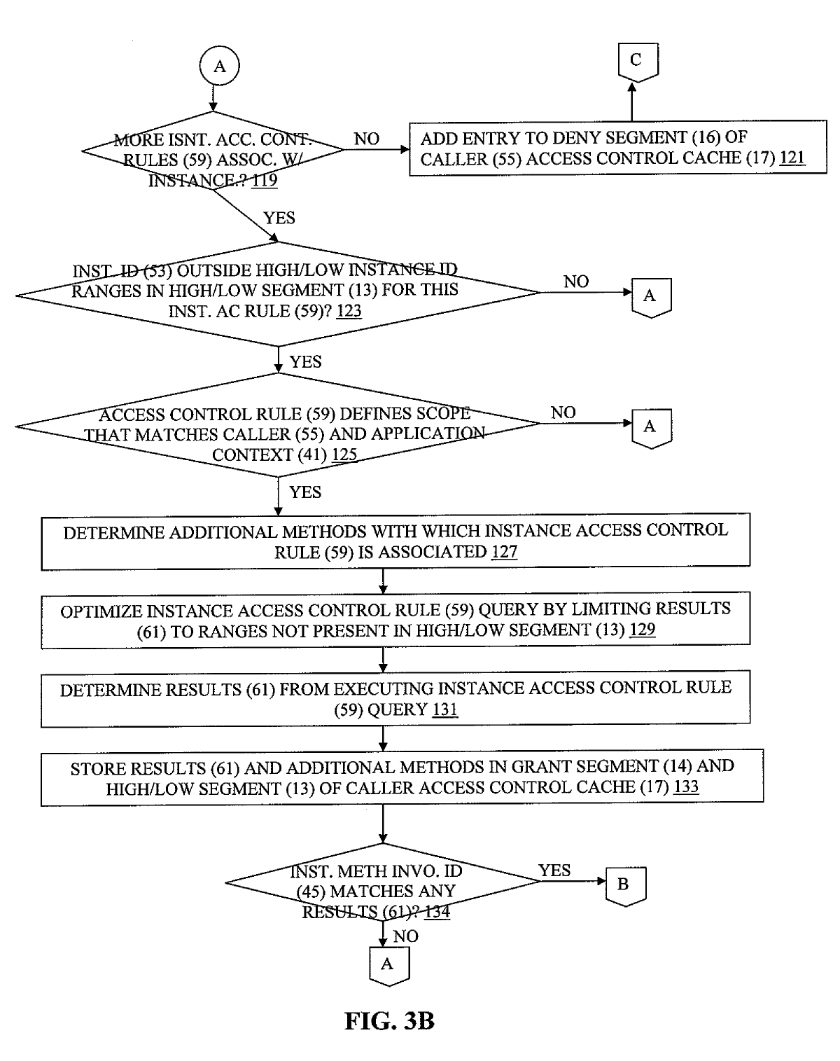

Referring now primarily to FIGS. 3A and 3B, method 200 can include, but is not limited to, the steps of intercepting 101, by interceptor 25 (FIG. 2), an instance of instance method 21 (FIG. 2) having instance method invocation identification (45) on an instance having instance identification 53 (FIG. 2). Method 200 can further include the steps of (a) determining 103 caller 55 (FIG. 2) of instance method invocation identification 45 (FIG. 2), (b) associating 105 the caller 55 (FIG. 2) with caller access control cache 17 (FIG. 2), and (c) associating 107 caller access control cache 17 (FIG. 2) with transaction 27 (FIG. 2). Caller access control cache 17 (FIG. 2) can include, but is not limited to including, for example, instance segment 15 (FIG. 2) including a set of instance method invocation identifications 45 (FIG. 2), a grant segment 14 (FIG. 2) including a grant set of instance method invocation identifications 45 (FIG. 2), a deny segment 16 (FIG. 2) including a deny set of instance method invocation identifications 45 (FIG. 2), a high/low segment 13 (FIG. 2) including a set of instance identification ranges for each access control rule.

Continuing to refer primarily to FIGS. 3A and 3B, if 109 (FIG. 2) instance method invocation identification 45 (FIG. 2) matches one of the set, or if 113 instance method invocation identification 45 (FIG. 2) matches one of the grant set, method 200 can include the step of (e) granting 111, to caller 55 (FIG. 2), access to the instance invoked by instance method 21 (FIG. 2) having instance method invocation identification 45 (FIG. 2). Method 200 can include the steps of (f) adding 135 instance method invocation identification 45 (FIG. 2) to the set and repeating steps (a) through (f) if 137 (FIG. 2) method invocation 46 (FIG. 2) created a new instance, and (g) denying 117, to caller 55 (FIG. 2), access to the instance invoked by the instance method 21 (FIG. 2) having instance method invocation identification 45 (FIG. 2) and repeating steps (a) through (g) if 115 instance method invocation identification 45 (FIG. 2) matches one of the deny set. If 119 there are no more instance access control rules 59 (FIG. 2) associated with the instance invoked by instance method 21 (FIG. 2) having instance method invocation identification 45 (FIG. 2), method 200 can include the step of (h) adding 121 instance method invocation identification 45 (FIG. 2) to deny segment 16 (FIG. 2) and repeating step (g). If 123 instance method invocation identification 45 (FIG. 2) is within the high/low set for instance access control rule 59 (FIG. 2), and if 125 instance access control rule 59 (FIG. 2) does not define a scope that matches caller 55 (FIG. 2) and an application context 41 (FIG. 2) associated with transaction 27 (FIG. 2), method 200 can (i) repeat step (h). If 119 there are more instance access control rules 59 (FIG. 2) associated with the instance, and if 123 instance method invocation identification 45 (FIG. 2) is outside the high/low set for instance access control rule 59 (FIG. 2), and if 125 instance access control rule 59 (FIG. 2) defines the scope that matches caller 55 (FIG. 2) and application context 41 (FIG. 2), method 200 can include the step of (j) determining 127 additional instance methods 21 (FIG. 2) with which instance access control rule 59 (FIG. 2) is associated. Method 200 can further include the steps of (k) optimizing 129 a query of instance access control rules 59 (FIG. 2) by limiting results 61 (FIG. 2) to ranges not present in high/low segment 13 (FIG. 2), (l) determining 131 results 61 (FIG. 2) from executing instance access control rule 59 FIG. 2) with the optimization, and (m) storing 133 results 61 (FIG. 2) and additional instance methods 21 (FIG. 2) with which instance access control rule 59 (FIG. 2) is associated in grant segment 14 (FIG. 2) and high/low segment 13 (FIG. 2) of caller access control cache 17 (FIG. 2). If 134 instance method invocation identification 45 (FIG. 2) matches an entry in results 61 (FIG. 2), method 200 can include the step of (n) granting 111, to caller 55 (FIG. 2), access to the instance invoked by instance method 21 (FIG. 2) having instance method invocation identification 45 (FIG. 2) and can repeat steps (a) through (f). If 134 instance method invocation identification 45 (FIG. 2) matches no entry in results 61 (FIG. 2), method 200 can (o) repeat steps (h)-(n).

Continuing to still further refer primarily to FIGS. 3A and 3B, in the illustrative embodiment, a query optimization including a per-rule high/low optimization algorithm may be accessed and manipulated through high/low segment 13 (FIG. 2) of caller access control cache 17 (FIG. 2). In high/low segment 13 (FIG. 2) of caller access control cache 17 (FIG. 2), for each access control rule 57 (FIG. 2), results 61 (FIG. 2) can include the high and low values of instance method invocation identifications 45, and whether or not that range represents the complete set of values that could be returned by the query. Unnecessary queries can be prevented when access control engine 11 (FIG. 2) already knows that results 61 (FIG. 2) will not include instance method invocation identification 45 (FIG. 2). A high/low complete flag for all access control rules 57 (FIG. 2) for a single object class 51 (FIG. 2) in all caller access control caches (17A-17n) can be cleared when a new instance of the single object class 51 (FIG. 2) is created. To minimize the size of results 61 (FIG. 2) in step (k), a query read-ahead, can, for example, modify a query at execution time to restrict its scope to a pre-selected number, for example five hundred, of the identifications nearest in value to instance method invocation identification 45 (FIG. 2). In the illustrative embodiment, scope restriction can be accomplished by adding a clause to the query, for example, WHERE id>=(id−499) AND id<ub ORDER BY id, where ‘ub’ is the low end of the nearest high/low range greater than id. This can limit the returned instance identifications to only those that have not been previously queried.

Although not shown in FIGS. 3A and 3B, the step of determining caller 55 (FIG. 2) of instance method invocation identification 45 (FIG. 2) can include, but is not limited to, the steps of accessing security context 31 (FIG. 2), mapping an application server security context object from security context 31 to a security object defined for access control engine 11 (FIG. 2), and determining, by associater 71 (FIG. 2), the identity of caller 55 (FIG. 2) based on the security object. Method 200 can further include the step of associating access control engine 11 (FIG. 2) with caller access control cache 17 (FIG. 2) which can include, but is not limited to, the steps of defining a structure for caller access control cache 17 (FIG. 2) to include object class name objects represented as a nested hash map having the grant set, the deny set, and the instance set associated with transaction 27 (FIG. 2), instance method invocation identifications 45 (FIG. 2) represented as a hash set, and a hierarchical data structure having levels including object class name, method group name, and instance method invocation identifications 45 (FIG. 2), defining the object class names and the method group names globally, and storing instance method invocation identification 45 (FIG. 2) in caller access control cache 17 (FIG. 2). Method 200 can even further include the steps of binding caller access control cache 17 (FIG. 3) to a thread-local variable, and defining global data elements to refer to names of object classes 51 and method groups in caller access control cache 17 (FIG. 2). Method 200 can further include the step of initializing access control engine 11 (FIG. 2) can include the steps of determining configuration information from an XML file, where configuration information can include transaction, security, and variable resolution connectors, defining a security object that is a representation of caller 55 (FIG. 2) for access control engine 11 (FIG. 2), and integrating queries defined outside of access control rules 57 (FIG. 2) with access control rules 57 (FIG. 2).

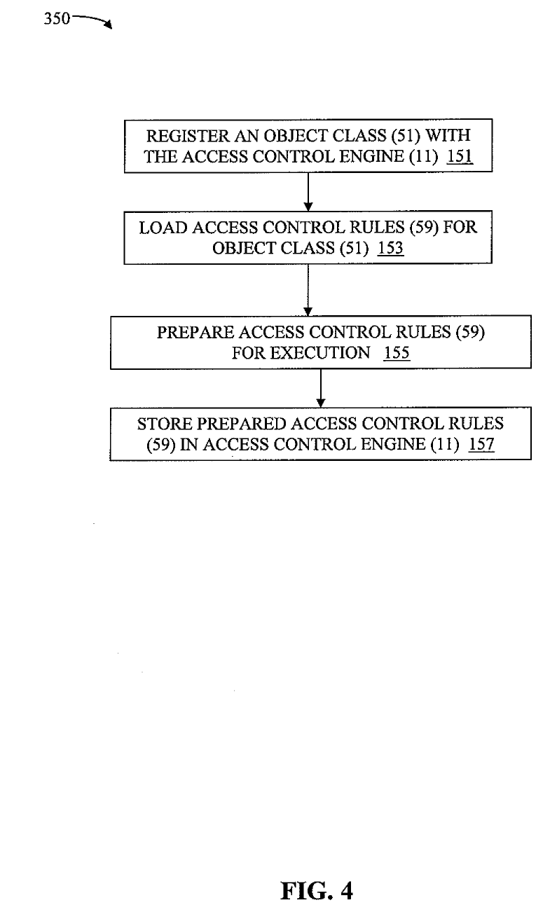

Referring now primarily to FIG. 4, method 350 can include the steps of registering 151 an object classes 51 (FIG. 2) with access control engine 11 (FIG. 2), loading 153 access control rules 57 (FIG. 2) for object class 51 (FIG. 2), preparing 155 access control rules 57 (FIG. 2) for execution, and storing 157 prepared access control rules in access control engine 11 (FIG. 2). The step of preparing 155 can include, but is not limited to including, the step of re-organizing access control rules 57 (FIG. 2) so that there is an instance access control rule 59 for each unique instance set (either “allow all” or a query) and each instance access control rule 59 then contains a set of “scopes”, each of which consists of user matching criteria and a list of method groups. This allows the access control engine 11 (FIG. 2) to maximize the benefit gained by the step of executing a database because the complete scope of method groups to which the results apply are aggregated together. The step of preparing 155 can further include the steps of re-ordering instance access control rules 59 (FIG. 2) such that those that do not require database interaction are checked first, and creating a linkage between individual methods and the list of instance access control rules 59 (FIG. 2) that are applicable. Because instance methods are grouped and access grants are given to instance method groups, the only way to determine which access control rules 57 (FIG. 2) apply to individual instance methods is to scan through access control rules 57 (FIG. 2) for each instance method 21 (FIG. 2). This can be done once as a setup step instead of on every access check. The step of preparing 155 can further include the step of importing access control rules 57 (FIG. 2) from one class to another where so defined, either, for example, once as a setup step or on every access check. The step of preparing 155 can further include the step of ensuring that within a rule definition structure, all class and method group names are represented by globally defined elements so that access control engine 11 (FIG. 2) can operate based on identity rather than content equality. In other words, access control rules 57 (FIG. 2) can be defined as instance methods 21 (FIG. 2) that are placed into groups, and as access grants. Each access grant can include a list of method groups, user matching criteria, and an instance identifier set either “allow all” or a list of database queries. Additionally, a class can “import” access control rules 57 from another class.

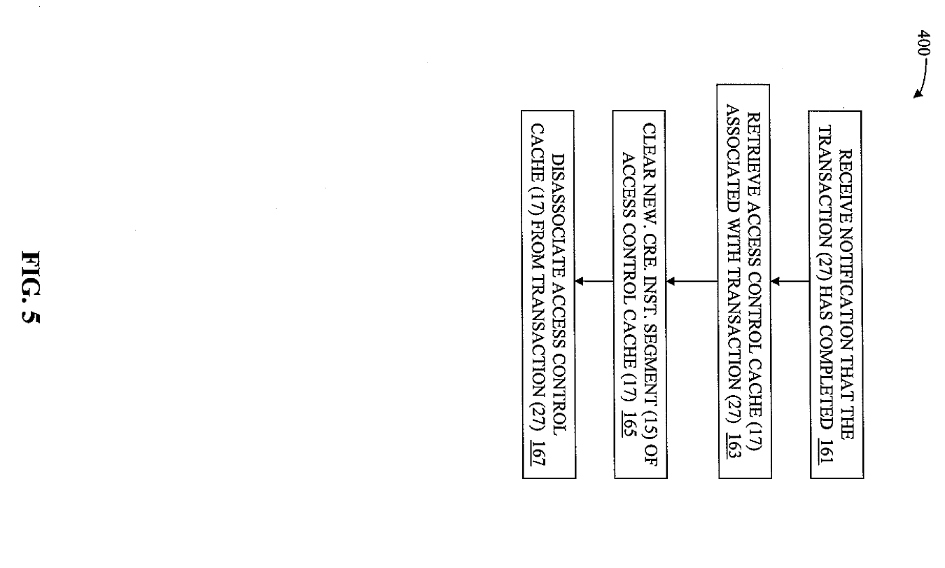

Referring now to FIG. 5, method 400 (FIG. 3A) can include the steps of receiving 161 notification that transaction 27 (FIG. 2) has completed, retrieving 163 caller access control cache 17 (FIG. 2) associated with transaction 27 (FIG. 2), clearing 165 instance segment 15 (FIG. 2) of caller access control cache 17 (FIG. 2), and disassociating 167 caller access control cache 17 (FIG. 2) from transaction 27 (FIG. 2).

Referring to FIGS. 1-5, method 200 (FIGS. 3A, 3B, 4, and 5) of the present embodiment can be, in whole or in part, implemented electronically. Signals representing actions taken by elements of system 100 (FIGS. 1 and 2) can travel over electronic communications media 19. Control and data information can be electronically executed and stored on computer-readable media 18. System 100 can be implemented to execute on a node such as applications server 23 in communications network 12. Common forms of computer-readable media 18 can include, but are not limited to, for example, a floppy disk, a flexible disk, a hard disk, magnetic tape, or any other magnetic medium, a CDROM or any other optical medium, punched cards, paper tape, or any other physical medium with patterns of holes or ink or characters, a RAM, a PROM, and EPROM, a FLASH-EPROM, or any other memory chip or cartridge, a carrier wave, or any other medium from which a computer can read.

Although various embodiments have been described herein, it should be realized that a wide variety of further and other embodiments is possible within the scope of this disclosure.

What is claimed is:

1. A method for controlling access to an instance method on an instance-specific basis comprising the steps of:
(a) intercepting an invocation of the instance method, having an instance method invocation identification, on an instance, having instance identification;
(b) determining a caller of the instance method invocation identification;
(c) associating the caller with a caller access control cache on a computer readable medium, the caller access control cache having an instance segment including a set of the instance method invocation identifications, the caller access control cache having a grant segment including a grant set of the instance method invocation identifications, the caller access control cache having a deny segment including a deny set of the instance method invocation identifications, the caller access control cache having a high/low segment including a set of ranges for the instance method invocation identifications for each access control rule;
(d) associating the caller access control cache with a transaction;
(e) granting, to the caller, access to the instance invoked by the instance method having the instance method invocation identification if the instance method invocation identification matches one of the set, or if the instance method invocation identification matches one of the grant set;
(f) adding the instance method invocation identification to the set and repeating steps (a) through (f) if the instance method invocation created a new instance;
(g) denying, to the caller, access to the instance invoked by the instance method having the instance method invocation identification and repeating steps (a) through (g) if the instance method invocation identification matches one of the deny set;
(h) adding the instance method invocation identification to the deny segment and repeating step (g) if there are no more of the instance access control rules associated with the instance invoked by the instance method having the instance method invocation identification;
(i) repeating step (h) if the instance method invocation identification is within the high/low set for the instance access control rule or if the instance access control rule does not define a scope that matches the caller and an application context associated with the transaction;
(j) determining additional of the instance methods with which the instance access control rule is associated if there are more of the instance access control rules associated with the instance, and if the instance method invocation identification is outside the high/low set for the instance access control rule, and if the instance access control rule defines the scope that matches the caller and the application context;
(k) optimizing a query of the instance access control rule;
(l) determining results from executing the optimized query of the instance access control rule;
(m) storing the results and additional of the instance methods with which the instance access control rule is associated in the grant segment and the high/low segment of the caller access control cache in the computer readable medium;
(n) granting, to the caller, access to the instance invoked by the instance method having the instance method invocation identification and repeating steps (a) through (f) if the instance method invocation identification matches an entry in the results; and
(o) repeating steps (h)-(n) if the instance method invocation identification matches no entry in the results.

2. The method of claim 1 wherein said step of optimizing further comprises the step of:
limiting the results to ranges not present in the high/low segment.

3. The method of claim 1 further comprising the steps of:
registering an object class with an access control engine;
loading the instance access control rules for the object class from the computer readable medium;
preparing the instance access control rules for execution; and
storing the prepared instance access control rules in the access control engine in the computer readable medium.

4. The method of claim 3 wherein said step of registering object classes comprises the step of:
optimizing a structure for the object class to accommodate access checking.

5. The method of claim 1 further comprising the steps of:
receiving a notification that the transaction has completed;
retrieving the caller access control cache associated with the transaction from the computer readable medium;
clearing the instance segment of the caller access control cache; and
disassociating the caller access control cache from the transaction.

6. The method of claim 1 further comprising the steps of:
initializing the access control engine including the steps of:
determining configuration information from an XML file on a computer readable medium, wherein the configuration information includes transaction, security, and variable resolution connectors;
defining a security object that is a representation of the caller that is understood by the access control engine; and
integrating queries defined outside of the access control rules with the access control rules.

7. The method of claim 6 wherein said step of determining a caller of instance method comprises the steps of:
accessing a security context;
mapping an application server security context object from the security context to a security object defined for the access control engine; and
determining, by the access control engine, the identity of the caller based on the security object.

8. The method of claim 1 further comprising the steps of:
associating an access control engine with the caller access control cache including the steps of:
defining a structure for the caller access control cache including a nested hash map of the grant set, the deny set, and the set associated with the transaction, and a hierarchical data structure having levels including object class names represented as a hash map, method group names represented as a hash map, and the instance method invocation identifications represented as a hash set;
defining the object class names and the method group names globally; and
storing the instance method invocation identification in the caller access control cache in the computer readable medium.

9. The method of claim 8 further comprising the steps of:
binding the access control cache to a thread-local variable; and
defining global data elements to refer to the object class names and the method group names in the caller access control cache.

10. A system for controlling access to an instance method on an instance-specific basis comprising:
a caller access control cache associated with a caller, said caller access control cache including:
an instance segment having a set of instance method invocation identifications;
a grant segment having a grant set of said instance method invocation identifications;
a deny segment having a deny set of said instance method invocation identifications; and
a high/low segment including a set of non-overlapping instance identification ranges for each access control rule;
an associater associating said caller access control cache with a transaction;
an interceptor intercepting an instance method invocation having said instance method invocation identification;
an access control engine:
granting said access to the caller to said instance invoked by said instance method having said instance method invocation identification if said instance method invocation identification matches one of said set, or if said instance method invocation identification matches one of said grant set;
adding said instance method invocation identification to said set if said instance method created an instance;
denying said access to the caller to said instance invoked by said instance method having said instance method invocation identification if said instance method invocation identification matches one of said deny set;
adding said instance method invocation identification to said deny segment if there are no more instance access control rules associated with said instance having said instance method invocation identification;
adding said instance method invocation identification to said deny segment if said instance method invocation identification is within said high/low set for said instance access control rule and if said instance access control rule does not define a scope that matches the caller and an application context associated with said transaction;
determining additional instance methods with which said instance access control rule is associated if there are more said instance access control rules associated with said instance, and if said instance method invocation identification is outside said high/low set for said instance access control rule, and if said instance access control rule defines said scope that matches the caller and said application context;
optimizing an instance access control rule query by limiting results to ranges not present in said high/low segment;
determining said results from executing the optimized instance access control rule query;
storing said results and said additional instance methods in said grant segment and said high/low segment of said caller access control cache;
granting said access to the caller to said instance invoked by the instance method having said instance method invocation identification if said instance method invocation identification matches an entry in said results; and
denying said access to the caller if said instance method invocation identification matches no entry in said results.

11. The system of claim 10 further comprising:
a registrar:
registering an object class with an access control engine;
loading said instance access control rules for said object class;
preparing said instance access control rules for execution; and
storing the prepared instance access control rules in said access control engine in a computer readable medium.

12. The system of claim 11 wherein said registrar further optimizes a structure for said object class to accommodate access checking.

13. The system of claim 10 further comprising:
a transaction terminator:
receiving a notification that said transaction has completed;
retrieving said caller access control cache associated with said transaction;
clearing said instance segment of said caller access control cache; and
disassociating said caller access control cache from said transaction.

14. The system of claim 10 further comprising:
an initializer for initializing said access control engine, wherein said initializer:
determines configuration information from an XML file, wherein said configuration information includes transaction, security, and variable resolution connectors;
defines a security object that is a representation of the caller that is understood by said access control engine; and
integrates queries defined outside of said access control rules with said access control rules.

15. The system of claim 10 wherein said associator further:
determines the caller;
determines, if said caller access control cache for the caller exists, said caller access control cache for the caller;
creates, if said caller access control cache for the caller does not exist, a new caller access control cache including a nested hash map of said grant set, said deny set, and said set associated with said transaction, and a hierarchical data structure having levels including object class names represented as a hash map, method group names represented as another hash map, and said instance method invocation identification represented as a hash set;
binds said access control cache to a thread-local variable;
retrieves a current transaction; and
registers a callback object with said current transaction so that said current transaction can receive notification of completion of said transaction.

16. A communication network comprising at least application server and at least one application client executing instructions to implement the steps of:
(a) intercepting an invocation of the instance method, having an instance method invocation identification, on an instance, having instance identification;
(b) determining a caller of the instance method invocation identification;
(c) associating the caller with a caller access control cache on a computer readable medium, the caller access control cache having an instance segment including a set of the instance method invocation identifications, the caller access control cache having a grant segment including a grant set of the instance method invocation identifications, the caller access control cache having a deny segment including a deny set of the instance method invocation identifications, the caller access control cache having a high/low segment including a set of ranges for the instance method invocation identifications for each access control rule;
(d) associating the caller access control cache with a transaction;
(e) granting, to the caller, access to the instance invoked by the instance method having the instance method invocation identification if the instance method invocation identification matches one of the set, or if the instance method invocation identification matches one of the grant set;
(f) adding the instance method invocation identification to the set and repeating steps (a) through (f) if the method invocation created a new instance;
(g) denying, to the caller, access to the instance invoked by the instance method having the instance method invocation identification and repeating steps (a) through (g) if the instance method invocation identification matches one of the deny set;
(h) adding the instance method invocation identification to the deny segment and repeating step (g) if there are no more of the instance access control rules associated with the instance invoked by the instance method having the instance method invocation identification;
(i) repeating step (h) if the instance method invocation identification is within the high/low set for the instance access control rule or if the instance access control rule does not define a scope that matches the caller and an application context associated with the transaction;
(j) determining additional of the instance methods with which the instance access control rule is associated if there are more of the instance access control rules associated with the instance, and if the instance method invocation identification is outside the high/low set for the instance access control rule, and if the instance access control rule defines the scope that matches the caller and the application context;
(k) optimizing a query of the instance access control rule;
(l) determining results from executing the optimized query of the instance access control rule;
(m) storing the results and additional of the instance methods with which the instance access control rule is associated in the grant segment and the high/low segment of the caller access control cache in the computer readable medium;
(n) granting, to the caller, access to the instance invoked by the instance method having the instance method invocation identification and repeating steps (a) through (f) if the instance method invocation identification matches an entry in the results; and
(o) repeating steps (h)-(n) if the instance method invocation identification matches no entry in the results.

17. An arrangement for embedding supplemental data in a signal embodied in electromagnetic signals traveling over a computer network carrying information for causing a computer system to practice of the steps of:
(a) intercepting an invocation of the instance method, having an instance method invocation identification, on an instance, having instance identification;
(b) determining a caller of the instance method invocation identification;
(c) associating the caller with a caller access control cache on a computer readable medium, the caller access control cache having an instance segment including a set of the instance method invocation identifications, the caller access control cache having a grant segment including a grant set of the instance method invocation identifications, the caller access control cache having a deny segment including a deny set of the instance method invocation identifications, the caller access control cache having a high/low segment including a set of ranges for the instance method invocation identifications for each access control rule;
(d) associating the caller access control cache with a transaction;
(e) granting, to the caller, access to the instance invoked by the instance method having the instance method invocation identification if the instance method invocation identification matches one of the set, or if the instance method invocation identification matches one of the grant set;
(f) adding the instance method invocation identification to the set and repeating steps (a) through (f) if the instance method invocation created a new instance;
(g) denying, to the caller, access to the instance invoked by the instance method having the instance method invocation identification and repeating steps (a) through (g) if the instance method invocation identification matches one of the deny set;
(h) adding the instance method invocation identification to the deny segment and repeating step (g) if there are no more of the instance access control rules associated with the instance invoked by the instance method having the instance method invocation identification;
(i) repeating step (h) if the instance method invocation identification is within the high/low set for the instance access control rule or if the instance access control rule does not define a scope that matches the caller and an application context associated with the transaction;
(j) determining additional of the instance methods with which the instance access control rule is associated if there are more of the instance access control rules associated with the instance, and if the instance method invocation identification is outside the high/low set for the instance access control rule, and if the instance access control rule defines the scope that matches the caller and the application context;
(k) optimizing a query of the instance access control rule;
(l) determining results from executing the optimized query of the instance access control rule;
(m) storing the results and additional of the instance methods with which the instance access control rule is associated in the grant segment and the high/low segment of the caller access control cache in the computer readable medium;
(n) granting, to the caller, access to the instance invoked by the instance method having the instance method invocation identification and repeating steps (a) through (f) if the instance method invocation identification matches an entry in the results; and
(o) repeating steps (h)-(n) if the instance method invocation identification matches no entry in the results.

18. A computer readable medium containing instructions for the practice of the steps of:
(a) intercepting an invocation of the instance method, having an instance method invocation identification, on an instance, having instance identification;
(b) determining a caller of the instance method invocation identification;
(c) associating the caller with a caller access control cache on a computer readable medium, the caller access control cache having an instance segment including a set of the instance method invocation identifications, the caller access control cache having a grant segment including a grant set of the instance method invocation identifications, the caller access control cache having a deny segment including a deny set of the instance method invocation identifications, the caller access control cache having a high/low segment including a set of ranges for the instance method invocation identifications for each access control rule;
(d) associating the caller access control cache with a transaction;
(e) granting, to the caller, access to the instance invoked by the instance method having the instance method invocation identification if the instance method invocation identification matches one of the set, or if the instance method invocation identification matches one of the grant set;
(i) adding the instance method invocation identification to the set and repeating steps (a) through (f) if the instance method invocation created a new instance;
(g) denying, to the caller, access to the instance invoked by the instance method having the instance method invocation identification and repeating steps (a) through (g) if the instance method invocation identification matches one of the deny set;
(h) adding the instance method invocation identification to the deny segment and repeating step (g) if there are no more of the instance access control rules associated with the instance invoked by the instance method having the instance method invocation identification;
(i) repeating step (h) if the instance method invocation identification is within the high/low set for the instance access control rule or if the instance access control rule does not define a scope that matches the caller and an application context associated with the transaction;
(j) determining additional of the instance methods with which the instance access control rule is associated if there are more of the instance access control rules associated with the instance, and if the instance method invocation identification is outside the high/low set for the instance access control rule, and if the instance access control rule defines the scope that matches the caller and the application context;
(k) optimizing a query of the instance access control rule;
(l) determining results from executing the optimized query of the instance access control rule;
(m) storing the results and additional of the instance methods with which the instance access control rule is associated in the grant segment and the high/low segment of the caller access control cache in the computer readable medium;
(n) granting, to the caller, access to the instance invoked by the instance method having the instance method invocation identification and repeating steps (a) through (f) if the instance method invocation identification matches an entry in the results; and
(o) repeating steps (h)-(n) if the instance method invocation identification matches no entry in the results.
